(19) United States
(12) Patent Application Publication
(10) Pub. No.: US 2025/0190434 A1
(43) Pub. Date: Jun. 12, 2025

(54) QUERY ACCURACY IMPROVEMENT

(71) Applicant: INTERNATIONAL BUSINESS MACHINES CORPORATION, Armonk, NY (US)

(72) Inventors: Xiao Xiao CHEN, Beijing (CN); Sheng Yan SUN, Beijing (CN); Peng Hui JIANG, Beijing (CN); Xiao Hui WANG, Beijing (CN)

(21) Appl. No.: 18/532,764

(22) Filed: Dec. 7, 2023

(51) Int. Cl. G06F 16/2453

(52) U.S. Cl. CPC G06F 16/24537

(57) ABSTRACT

Computer implemented methods, systems, and computer program products include program code executing on a processor(s) that executes a query in the database that includes a SELECT statement that targets a base table. The program code generates an intermediate pending table with a table structure based on the SELECT statement. The program code determines that an INSERT operation inserted a record into the base table behind the fetch on the base table performed based on the SELECT statement. The program code inserts the record into the intermediate pending table in the table structure. The program code performs, based on the SELECT statement, a fetch on the intermediate pending table. The program code generates output for the SELECT statement by merging results of the fetch on the base table and the fetch on the intermediate pending table.

### BACKGROUND

The present invention relates generally to the field of database management, and specifically, to increasing the accuracy of query results.

The accuracy of query results is dependent on the accuracy of the data from which the results are returned. The product or process that obtains these results is often dependent upon the accuracy of the results. However, sometimes the results that are returned are inaccurate because the data in the database may be in a state that is different than whatever representation of the data the query hits to produce the results. For performance reasons, the database itself is often not the direct target of all (e.g., application, user) queries. Inaccurate results can be returned when a query is executed under high concurrency in an environment which runs jobs to insert data on the same table from which the query is pulling results.

One example of when a query can return inaccurate (e.g., incomplete) results can occur when a query runs within a special access path, such as an access path with list prefetch. In this example, the query can return inaccurate data because a list prefetch will ignore other changes implemented in these data after fetching the record identifiers (RIDs). For example, when a query is executed, an index of a target table can be used to obtain the RIDs which meet the WHERE condition in the query, and then, after obtaining the RIDs, to retrieve these data by using the RIDs. But during the period of retrieving data, concurrent jobs may insert data into the target table. Because new data was inserted, additional data may meet the WHERE condition, but because the query already amassed the RIDs, it will return only data based on the RIDs and the results will not include any changes, including the new data that met the WHERE condition after the insertion.

### SUMMARY

Shortcomings of the prior art are overcome, and additional advantages are provided through the provision of a computer-implemented method for obtaining accurate results for a query in a database. The method can include: executing, by one or more processors, in the database, a query comprising a SELECT statement, wherein the SELECT statement targets a base table, wherein the executing comprises performing a fetch on the base table based on the SELECT statement; generating, by the one or more processors, an intermediate pending table with a table structure based on the SELECT statement; determining, by the one or more processors, that an INSERT operation inserted a record into the base table behind the fetch on the base table performed based on the SELECT statement; inserting, by the one or more processors, the record into the intermediate pending table in the table structure; performing, by the one or more processors, based on the SELECT statement, a fetch on the intermediate pending table; and generating, by the one or more processors, output for the SELECT statement, wherein the generating comprises merging results of the fetch on the base table and the fetch on the intermediate pending table.

Shortcomings of the prior art are overcome, and additional advantages are provided through the provision of a computer program product for obtaining accurate results for a query in a database. The computer program product comprises a storage medium readable by a one or more processors and storing instructions for execution by the one or more processors for performing a method. The method includes, for instance: executing, by the one or more processors, in the database, a query comprising a SELECT statement, wherein the SELECT statement targets a base table, wherein the executing comprises performing a fetch on the base table based on the SELECT statement; generating, by the one or more processors, an intermediate pending table with a table structure based on the SELECT statement; determining, by the one or more processors, that an INSERT operation inserted a record into the base table behind the fetch on the base table performed based on the SELECT statement; inserting, by the one or more processors, the record into the intermediate pending table in the table structure; performing, by the one or more processors, based on the SELECT statement, a fetch on the intermediate pending table; and generating, by the one or more processors, output for the SELECT statement, wherein the generating comprises merging results of the fetch on the base table and the fetch on the intermediate pending table.

Shortcomings of the prior art are overcome, and additional advantages are provided through the provision of a system for obtaining accurate results for a query in a database. The system includes: a memory, one or more processors in communication with the memory, and program instructions executable by the one or more processors via the memory to perform a method. The method includes, for instance: executing, by the one or more processors, in the database, a query comprising a SELECT statement, wherein the SELECT statement targets a base table, wherein the executing comprises performing a fetch on the base table based on the SELECT statement; generating, by the one or more processors, an intermediate pending table with a table structure based on the SELECT statement; determining, by the one or more processors, that an INSERT operation inserted a record into the base table behind the fetch on the base table performed based on the SELECT statement; inserting, by the one or more processors, the record into the intermediate pending table in the table structure; performing, by the one or more processors, based on the SELECT statement, a fetch on the intermediate pending table; and generating, by the one or more processors, output for the SELECT statement, wherein the generating comprises merging results of the fetch on the base table and the fetch on the intermediate pending table.

Computer systems and computer program products relating to one or more aspects are also described and may be claimed herein. Further, services relating to one or more aspects are also described and may be claimed herein.

Additional aspects of the present disclosure are directed to systems and computer program products configured to perform the methods described above. Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to perform, include and/or use one or more aspects of the present disclosure;

FIG. 2 is a workflow that provides an overview of various aspects performed by the program code (executing on one or more processors) in some embodiments of the present disclosure;

FIG. 3 is an illustration of an issue addressed by various aspects of some examples herein;

FIG. 4 illustrates various aspects of some examples herein;

FIG. 5 illustrates various aspects of some examples herein;

FIG. 6 is an illustration of an issue addressed by various aspects of some examples herein and how certain of these aspects address this issue;

FIG. 7 illustrates various aspects of some examples herein; and

FIG. 8 illustrates various aspects of some examples herein.

### DETAILED DESCRIPTION

The examples herein disclose computer-implemented methods, computer program products, and computer systems where program code executing on one or more processors performs a data retrieval method that is effective in an environment with high-concurrency. In retrieving accurate data (based on the timing of the query), the program code judges retrieval types corresponding to the data retrieval requests to return temporally accurate results.

Inaccurate results can be returned when a query is executed in a high concurrency environment which runs jobs to insert data on the same table from which the query is pulling results. Embodiments of the present invention include computer-implemented methods, computer program products, and computer systems that promote output accuracy of database queries (e.g., SELECT statements) even when executed in a database system with a heavy workload with high concurrency. It is in these database systems with heavy workloads and high concurrency that a select statement will pull inaccurate results because an INSERT statement or other process makes changes to the data at a point in the query where the newly changed data will not be returned to the user. To promote accuracy, in response to query statements, program code generates an intermediate pending table which includes column values referenced by the SELECT statement. Thus, when an INSERT operation modifies the table that is being queried by a SELECT statement, if based in the timing of the insert and the progress of the SELECT statement, the record inserted by the INSERT operation will not be retrieved by the SELECT statement, program code executing on one or more processors inserts the record into this intermediate pending table. The SELECT statement can evaluate the rows in intermediate pending table and thus, can output a results set which accurately reflects the status of data more closely at the time that the results are returned to the user or process which initiated the query.

Embodiments of the present invention are inextricably tied to computing. The examples herein provide a computer-based solution to an issue in computing. The examples herein relate to increasing the accuracy of database queries and provide a solution that includes program code executing on one or more processors generating and updating a database object. Query optimization, which includes improving query accuracy, is a practical application that is inextricably tied to computing and is achieved in the examples described herein.

The examples herein are directed to a practical application. As noted earlier, data returned by queries in high concurrency environments can be incorrect because the query, before returning the data, will identify the rows where the responsive data is located, and between the identification and the retrieval, new rows can be inserted by other processes and the data in some of these rows can be relevant to the query and, therefore, if retrieved, would change the results set. Thus, some queries can return data that is not a current response to the query at the time that it is returned. In plain terms, the current behavior of an INSERT operation and a SELECT statement under high concurrency is that the SELECT statement cannot output a qualified record which is inserted behind the record retrieved by the SELECT statement at a certain point of time. The examples herein are directed to a practical application because they improve query result accuracy and in particular, the examples provide a practical approach to a known issue.

The examples herein provide significantly more than existing approaches to improving query result accuracy in the situation described herein. Existing approaches to this issue have various drawbacks. For example, one can utilize a process to adjust the sequence of jobs to complete the INSERT operation before running the query. However, this the process can affect the business logic, and it cannot be performed in highly concurrent environments. As noted above, it is in these highly concurrent environments that this issue is most prevalent and hence, an approach that cannot address this issue in this type of environment is impractical. Another approach is upgrading the isolation level of the SELECT statement, but this approach results in the performance of the INSERT operation diminishing, creating wait time, which will affect overall query performance in the database. In contrast, the examples herein can be implemented in highly concurrent environments and do not adversely affect the performance of querying in these environments, while addressing the issue noted by returning correct (at the time) data for queries (e.g., SELECT statements). The significant advantages of the examples herein include but are not limited to: 1) improving the accuracy of SELECT operations, including in systems with heavy workloads with high concurrency; 2) achieving the aforementioned accuracy advantages without decreasing the performance of (e.g., a concurrent or overlapping) INSERT operation; and 3) achieving the aforementioned accuracy advantages without changing the sequence of business jobs.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random-access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

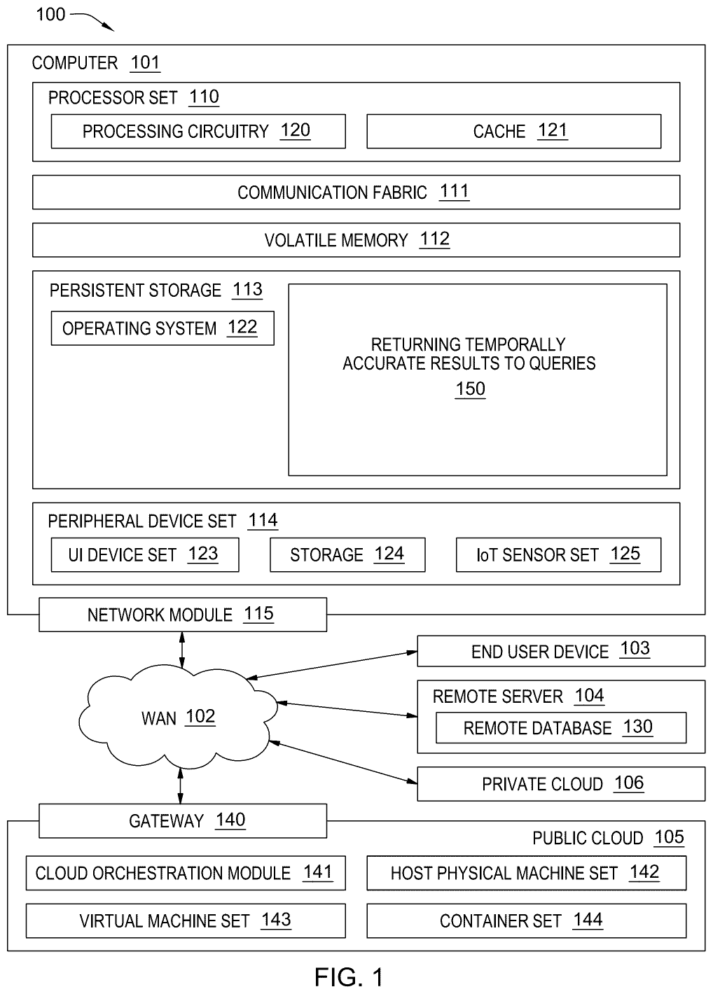

One example of a computing environment to perform, incorporate and/or use one or more aspects of the present disclosure is described with reference to FIG. 1. In one example, a computing environment 100 contains an example of an environment for the execution of at least some of the computer code involved in performing the inventive methods, such as a code block for returning temporally accurate results to queries including in environments with high concurrency 150. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allow the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation and/or review to an end user, this recommendation would typically be communicated from network module 115 of computer 101 through WAN 102 to EUD 103. In this way, EUD 103 can display, or otherwise present, the recommendation and/or review to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation and/or review based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

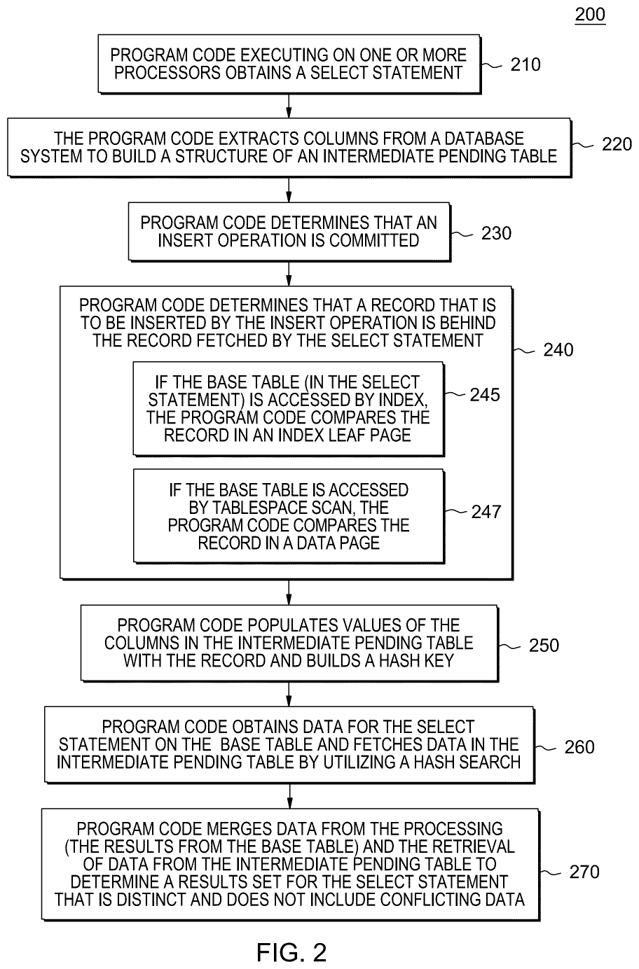

FIG. 2 is a workflow 200 that illustrates various aspects of some examples herein. Some of these aspects will be explained in more detail in subsequent figures. However, FIG. 2 is included to provide a general overview of aspects of various examples. Referring to FIG. 2, program code executing on one or more processors obtains a SELECT statement (210). Based on the SELECT statement, which can include a data length referenced by the SELECT statement, the program code extracts columns from a database system (e.g., from the base table referenced by the SELECT statement) to build a structure of an intermediate pending table (220). In some examples, the columns that the program code extracts include, data type, and data length referenced by the SELECT statement based on the parse tree of the SELECT statement. The program code determines that an INSERT operation is committed (230). Based on determining that an INSERT operation is committed, the program code checks if a record that is to be inserted by the INSERT operation is behind the record fetched by the SELECT statement (240). To make this determination, if the base table (in the SELECT statement) is accessed by index, the program code compares the record in an index leaf page (245). If the base table is accessed by tablespace scan, the program code compares the record in a data page (247). Based on determining that the record that is to be inserted by the INSERT operation is behind the record fetched by the SELECT statement, the program code populates values of the columns in the intermediate pending table with data from the record and builds a hash key (250). The program code obtains data for the SELECT statement on the base table and fetches data in the intermediate pending table by utilizing a hash search (260). The program code merges data from the processing (the results from the base table and the retrieval of data from the intermediate pending table) to determine a results set for the SELECT statement that is distinct and does not include conflicting data (270).

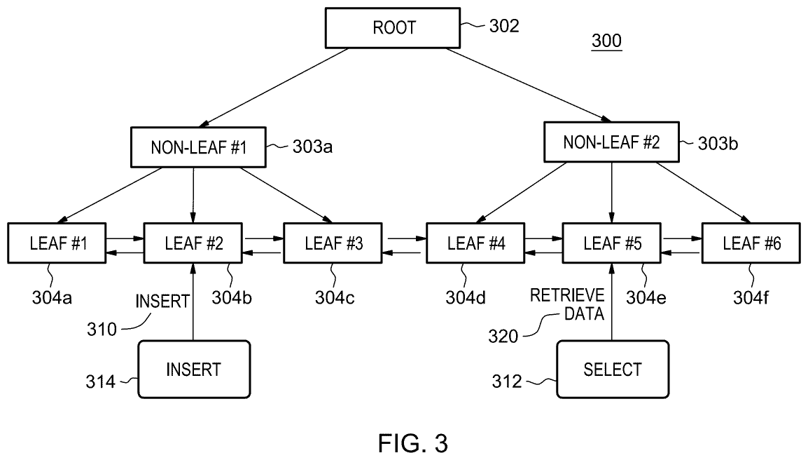

FIG. 3 is a diagram 300 that illustrates a parse tree of a query and illustrates the issue addressed by various examples herein. Specifically, FIG. 3 illustrates current behavior of an INSERT operation and a SELECT statement under high concurrency: a SELECT statement cannot output a qualified record which is inserted (e.g., by the INSERT operation) behind the record retrieved by the SELECT statement at a certain point of time. The example in FIG. 3 illustrates this issue when a record is accessed by index (although the same issue can exist in current systems without the aspects disclosed herein when records are accessed by tablespace scan). The parse tree in FIG. 3 includes a root 302 (topmost node), non-leaves 303a-303b (non-terminal nodes in the parse tree), and leaves 304a-f (terminal nodes of the parse tree). A SELECT statement 312 includes criteria which is met by two of the leaf nodes, leaf node #2 304b and leaf node #5 304c. However, INSERT operation 314 inserted (310) leaf node #2 304b behind the record fetched by the SELECT statement, leaf node #5 304e. Thus, the query retrieves data (320) that includes only leaf node #5 304c, rather than leaf node #2 304b and leaf node #5 304c. In this example, both leaf node #5 304c and leaf node #2 304b fit the parameters on the SELECT statement.

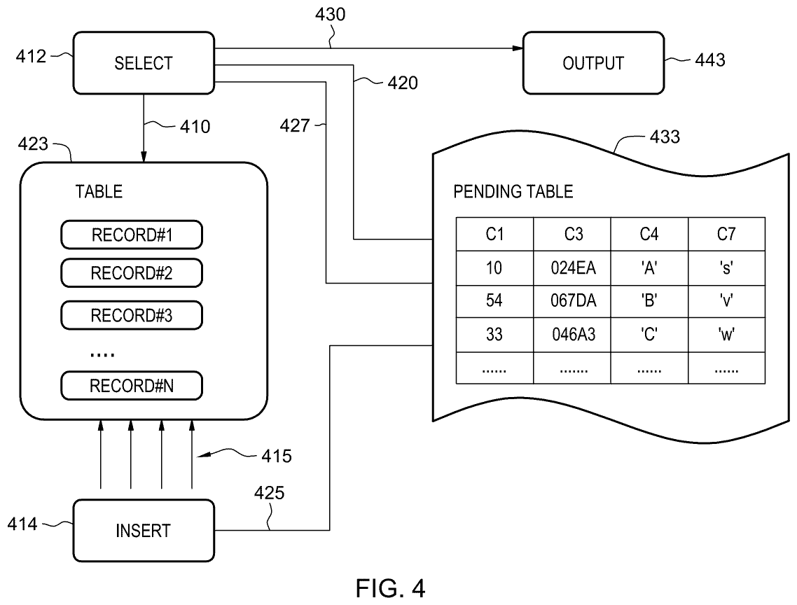

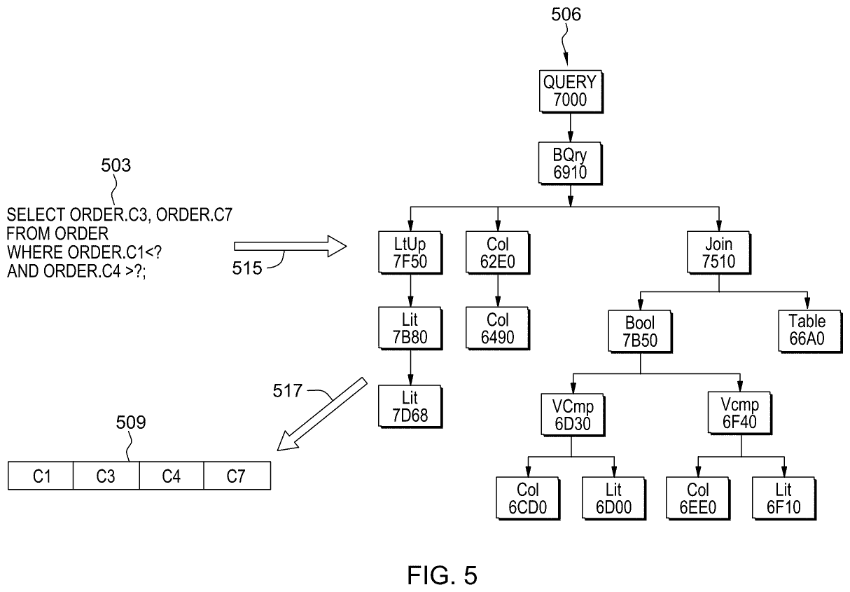

FIG. 4 is an overview of various examples herein. FIGS. 5-8 further illustrate various aspects illustrated in the comprehensive FIG. 4. FIGS. 4-8 illustrate how the issue illustrated in FIG. 3 is addressed in the examples herein.

Referring to FIG. 4, in some examples, a SELECT statement 412 is executed (by the program code) on a base table 423 (410). The program code determines that certain of the records (Record #1-Record #N) inserted in the base table 423 were inserted by the INSERT operation 414 behind the records fetched as results for the SELECT statement 412. The program code generates an intermediate pending table 433 with a structure based on a parse tree of the SELECT statement 412 (420). An INSERT operation 414 is executed (by program code) behind the SELECT statement 412 (415). The program code inserts the record inserted into the base table 423 into the intermediate pending table 433 (which can be retrieved with a hash search key) (425). The program code obtains results for the SELECT statement 412 (430) by: 1) executing it on the base table 423 (410); and 2) fetching data from the intermediate pending table 433 (e.g., performing a hash search) (427). Thus, the output 443 (query results) includes current data and does not miss records inserted in the base table 423 behind the fetched records.

FIG. 5 illustrates how in some examples herein the program code extracts columns from a database system to build a structure of an intermediate pending table (e.g., FIG. 2, 220, FIG. 4, 420, 433). In these examples, program code executing on at least one processor extracts columns including data type, data length referenced by the SELECT statement, based the query parse tree, to build the structure of intermediate pending table. FIG. 5 utilizes the non-limiting example of the query below. This query 503 also appears in FIG. 5.
SELECT ORDER.C3, ORDER.C7
FROM ORDER
WHERE ORDER.C1<?
AND ORDER.C4>?;

This SELECT statement selects columns C3 and C7 from the table ORDER where column C1 of the ORDER table is less than “?” and column C4 of the order table is greater than “?”. Upon obtaining the query, program code executing on one or more processors generates a parse tree 506 (515). Based on the parse tree 506, the program code extracts columns C1, C3, C4, and C7 as the structure 509 of the intermediate pending table (517).

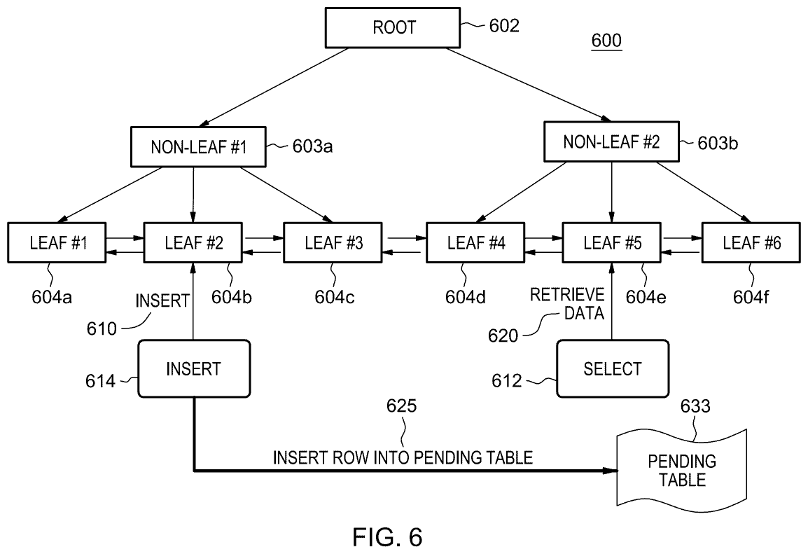

FIG. 6 is similar to FIG. 3, but FIG. 6 illustrates how examples herein address the issue illustrated in FIG. 3. Like FIG. 3, FIG. 6 illustrates this issue when a record is accessed by index (although the same issue can exist in current systems without the aspects disclosed herein when records are accessed by tablespace scan). The parse tree in FIG. 6 includes a root 602 (topmost node), non-leaves 603a-603b (non-terminal node is the parse tree), and leaves 304a-f (terminal nodes of the parse tree). A SELECT statement 612 includes criteria which is met by two of the leaf nodes, leaf node #2 604b and leaf node #5 604e. The INSERT operation 614 inserted (610) leaf node #2 604b behind the record fetched by the SELECT statement, leaf node #5 604e. Thus, the program code inserts a row that includes leaf node #2 604b in the intermediate pending table 633 (625). Thus, the results of the SELECT statement 612 provided to the entity making the query will include both leaf node #2 604b and leaf node #5 604e. The results will be more current (e.g., complete) than without the use of the intermediate pending table 633.

As illustrated in FIG. 6, when the INSERT operation 614 was committed, the program code checks if the inserted record was behind the record fetched by the SELECT statement 612 (e.g., FIG. 2, 240). In some examples, to check if an inserted record is behind a record fetched by the SELECT statement, if the table is accessed by index, the program code compares the record in index leaf page, and if table is accessed by tablespace scan, the program code compares the record in a data page (e.g., FIG. 2, 245, 247).

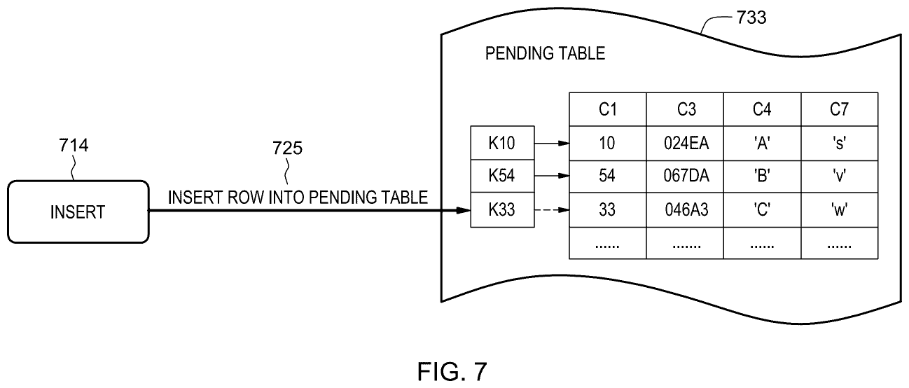

As discussed in FIG. 2, the program code populates values of the columns into the intermediate pending table and builds a hash key (250). To this end, FIG. 7 illustrates the program code inserting records the program code (e.g., the INSERT operation 714) inserted into the base table, into the intermediate pending table 733 (e.g., FIG. 4, 425). The program code builds the structure of the intermediate pending table 733 based on a SELECT statement (as illustrated in FIG. 5) and populates records in the intermediate pending table 733 based on the INSERT operation 714. Based on the program code determining that a record that is to be inserted by the INSERT operation 714 is behind the record fetched by the SELECT statement, the program code inserts the row (record) K33, into the intermediate pending table 733.

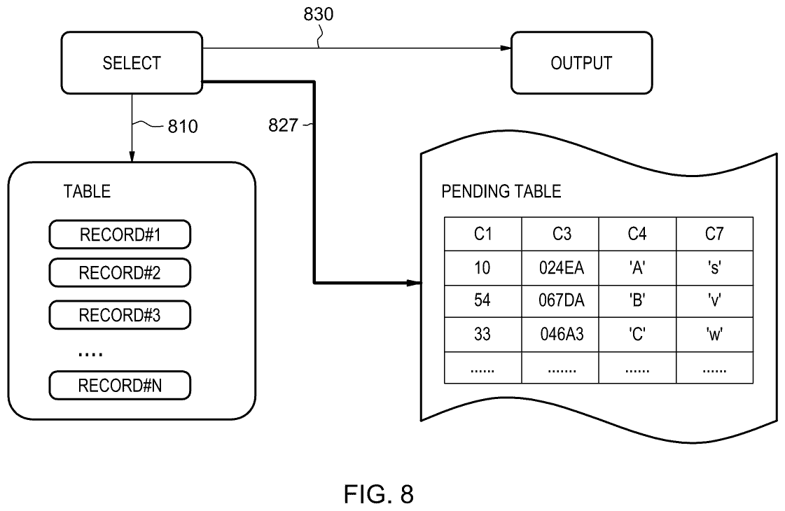

As discussed, and illustrated in FIG. 4, the program code obtains results for the SELECT statement (430) 412 by: 1) executing it on the base table 423 (410); and 2) fetching data from the intermediate pending table 433 (e.g., performing a hash search) (427). Thus, the output 443 (query results) includes current data and does not miss records inserted in the base table 423 behind the fetched records. This portion of the approach described herein is illustrated in FIG. 8. FIG. 8 illustrates how in certain examples herein, program code executing on one or more processors processes data for the SELECT statement 812 on the base table 823 (810) and fetches data in the intermediate pending table 833 (827). These data (from the base table 823 and the intermediate pending table 833, if relevant based on the SELECT statement 812), de-duped or otherwise cleaned as needed, are the output 843 of the SELECT statement 812 (query) (830).

Embodiments of the present invention include computer-implemented methods, computer program products, and computer systems where program code executing on one or more processors executes, in a database, a query comprising a SELECT statement. The SELECT statement targets a base table and executing the query includes performing a fetch on the base table based on the SELECT statement. The program code generates an intermediate pending table with a table structure based on the SELECT statement. The program code determined that an INSERT operation inserted a record into the base table behind the fetch on the base table performed based on the SELECT statement. The program code inserts the record into the intermediate pending table in the structure. The program code performs, based on the SELECT statement, a fetch on the intermediate pending table. The program code generates output for the SELECT statement by merging results of the fetch on the base table and the fetch on the intermediate pending table.

In some examples, the program code inserting the record into the intermediate pending table comprises the program code building a hash key.

In some examples, the program code performing the fetch on the intermediate pending table comprises the program code utilizing a hash search.

In some examples, the program code determining that the INSERT operation inserted the record into the base table behind the fetch on the base table comprises the program code determining that the INSERT operation is committed.

In some examples, the program code determining that the INSERT operation inserted the record into the base table behind the fetch on the base table comprises: the program code determining that the base table is accessed in the SELECT statement by index, based on the determining, the program code comparing the record in an index leaf page.

In some examples, the program code determining that the INSERT operation inserted the record into the base table behind the fetch on the base table comprises: the program code determining that the base table is accessed in the SELECT statement by tablespace scan, and based on the determining, the program code comparing the record in a data page.

In some examples, the program code returns the output to the query.

In some examples, the program code generating the intermediate pending table further comprises: the program code generating a parse tree for the SELECT statement, and the program code utilizing the parse tree to generate a table structure.

In some examples, the program code generating the intermediate pending table further comprises: the program code extracting, based on the SELECT statement, columns from the base table.

In some examples, the columns comprise data type and data length.

Although various embodiments are described above, these are only examples. For example, reference architectures of many disciplines may be considered, as well as other knowledge-based types of code repositories, etc., may be considered. Many variations are possible.

Various aspects and embodiments are described herein. Further, many variations are possible without departing from a spirit of aspects of the present disclosure. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

1. A computer-implemented method of obtaining accurate results for a query in a database, the method comprising:
executing, by one or more processors, in the database, a query comprising a SELECT statement, wherein the SELECT statement targets a base table, wherein the executing comprises performing a fetch on the base table based on the SELECT statement;
generating, by the one or more processors, an intermediate pending table with a table structure based on the SELECT statement, wherein the generating comprises extracting one or more columns referenced by the SELECT from the base table, the columns selected from the group consisting of: data type and data length;
determining, by the one or more processors, that an INSERT operation inserted a record into the base table behind the fetch on the base table performed based on the SELECT statement;
inserting, by the one or more processors, the record into the intermediate pending table in the table structure;
performing, by the one or more processors, based on the SELECT statement, a fetch on the intermediate pending table; and
generating, by the one or more processors, output for the SELECT statement, wherein the generating comprises merging results of the fetch on the base table and the fetch on the intermediate pending table.

2. The computer-implemented method of claim 1, wherein inserting the record into the intermediate pending table comprises building a hash key.

3. The computer-implemented method of claim 2, wherein performing the fetch on the intermediate pending table comprises utilizing a hash search.

4. The computer-implemented of claim 1, wherein determining that the INSERT operation inserted the record into the base table behind the fetch on the base table comprises:
determining, by the one or more processors, that the INSERT operation is committed.

5. The computer-implemented of claim 1, wherein determining that the INSERT operation inserted the record into the base table behind the fetch on the base table comprises:
determining, by the one or more processors, that the base table is accessed in the SELECT statement by index; and
based on the determining, comparing, by the one or more processors, the record in an index leaf page.

6. The computer-implemented of claim 1, wherein determining that the INSERT operation inserted the record into the base table behind the fetch on the base table comprises:
determining, by the one or more processors, that the base table is accessed in the SELECT statement by tablespace scan; and
based on the determining, comparing, by the one or more processors, the record in a data page.

7. The computer-implemented method of claim 1, further comprising:
returning, by the one or more processors, the output to the query.

8. The computer-implemented method of claim 1, wherein generating the intermediate pending table further comprises:
generating, by the one or more processors, a parse tree for the SELECT statement; and
utilizing, by the one or more processors, the parse tree to generate the table structure.

9. The computer-implemented method of claim 1, wherein generating the intermediate pending table further comprises:
extracting, by the one or more processors, based on the SELECT statement, columns from the base table.

10. The computer-implemented method of claim 1, wherein the columns comprise data type and data length.

11. A computer system for obtaining accurate results for a query in a database, the computer system comprising:
a memory; and
one or more processors in communication with the memory, wherein the computer system is configured to perform a method, said method comprising:
executing, by the one or more processors, in the database, a query comprising a SELECT statement, wherein the SELECT statement targets a base table, wherein the executing comprises performing a fetch on the base table based on the SELECT statement;
generating, by the one or more processors, an intermediate pending table with a table structure based on the SELECT statement, wherein the generating comprises extracting one or more columns referenced by the SELECT from the base table, the columns selected from the group consisting of: data type and data length;
determining, by the one or more processors, that an INSERT operation inserted a record into the base table behind the fetch on the base table performed based on the SELECT statement;
inserting, by the one or more processors, the record into the intermediate pending table in the table structure;
performing, by the one or more processors, based on the SELECT statement, a fetch on the intermediate pending table; and
generating, by the one or more processors, output for the SELECT statement, wherein the generating comprises merging results of the fetch on the base table and the fetch on the intermediate pending table.

12. The computer system of claim 11, wherein inserting the record into the intermediate pending table comprises building a hash key.

13. The computer system of claim 12, wherein performing the fetch on the intermediate pending table comprises utilizing a hash search.

14. The computer system of claim 11, wherein determining that the INSERT operation inserted the record into the base table behind the fetch on the base table comprises:
determining, by the one or more processors, that the INSERT operation is committed.

15. The computer system of claim 11, wherein determining that the INSERT operation inserted the record into the base table behind the fetch on the base table comprises:
determining, by the one or more processors, that the base table is accessed in the SELECT statement by index; and
based on the determining, comparing, by the one or more processors, the record in an index leaf page.

16. The computer system of claim 11, wherein determining that the INSERT operation inserted the record into the base table behind the fetch on the base table comprises:
determining, by the one or more processors, that the base table is accessed in the SELECT statement by tablespace scan; and
based on the determining, comparing, by the one or more processors, the record in a data page.

17. The computer system of claim 11, further comprising:
returning, by the one or more processors, the output to the query.

18. The computer system of claim 11, wherein generating the intermediate pending table further comprises:
generating, by the one or more processors, a parse tree for the SELECT statement; and
utilizing, by the one or more processors, the parse tree to generate the table structure.

19. The computer system of claim 11, wherein generating the intermediate pending table further comprises:
extracting, by the one or more processors, based on the SELECT statement, columns from the base table.

20. A computer program product for obtaining accurate results for a query in a database, the computer program product comprising:
one or more computer readable storage media and program instructions collectively stored on the one or more computer readable storage media readable by at least one processing circuit to:
execute, by the one or more processors, in the database, a query comprising a SELECT statement, wherein the SELECT statement targets a base table, wherein the executing comprises performing a fetch on the base table based on the SELECT statement;
generate, by the one or more processors, an intermediate pending table with a table structure based on the SELECT statement by extracting one or more columns referenced by the SELECT from the base table, the columns selected from the group consisting of: data type and data length;
determine, by the one or more processors, that an INSERT operation inserted a record into the base table behind the fetch on the base table performed based on the SELECT statement;
insert, by the one or more processors, the record into the intermediate pending table in the table structure;
perform, by the one or more processors, based on the SELECT statement, a fetch on the intermediate pending table; and
generate, by the one or more processors, output for the SELECT statement, wherein the generating comprises merging results of the fetch on the base table and the fetch on the intermediate pending table.
